(19) United States
(12) Patent Application Publication
(10) Pub. No.: US 2026/0296539 A1
(43) Pub. Date: Oct. 1, 2026

(54) HINGE ASSEMBLY FOR UNDERCARRIAGE SYSTEM OF WORK MACHINE

(71) Applicant: Caterpillar Paving Products Inc., Brooklyn Park, MN (US)

(72) Inventor: Daniel Jonathan Heim, Blaine, MN (US)

(73) Assignee: Caterpillar Paving Products Inc., Brooklyn Park, MN (US)

(21) Appl. No.: 19/097,209

(22) Filed: Apr. 1, 2025

(51) Int. Cl. B62D 12/00; B62D 11/20; E01C 23/088

(52) U.S. Cl. CPC B62D 12/00; B62D 11/20; E01C 23/088

(57) ABSTRACT

A hinge assembly for an undercarriage system of a work machine includes a first bracket assembly including a first bracket coupled with a track frame, a second bracket coupled with a leg column. The first bracket and the second bracket are pivotable relative to each other. The hinge assembly also includes a second bracket including a third bracket coupled with the track frame, and a fourth bracket coupled with the leg column. The third bracket and the fourth bracket are pivotable relative to each other. The hinge assembly further includes a coupling member that removably couples the first bracket assembly with the second bracket assembly. The coupling member allows a pivoting of each of the first bracket relative to the second bracket and the third bracket relative to the fourth bracket to allow a pivoting motion of the track about a lateral axis of the work machine.

### TECHNICAL FIELD

The present disclosure generally relates to work machines having undercarriage systems and, more particularly, to an undercarriage system for a work machine, a hinge assembly for the undercarriage system of the work machine, and a method of pivoting a track of the undercarriage system of the work machine.

### BACKGROUND

A work machine, such as a milling machine or an excavator, are used to perform various operations as worksites. Some of these work machines include an undercarriage system for moving the work machine on surfaces. The undercarriage system includes a pair of front tracks and a pair of rear tracks for propulsion of the work machine. The undercarriage system also includes a track frame which is coupled with a corresponding leg column. Each track is supported on a corresponding track frame.

Typically, the track frame of the work machine can only pivot in fore and aft directions. In situations wherein the work machine experiences bumps or depressions, the tracks of the work machine experience uneven wear and may exhibit reduced traction, due to a limited range of the motion of the track frame. In some cases, due to the limited range of motion of the track frame, the track may be edge loaded, and undesirable stress may be exerted on undercarriage components, such as track rollers, idler rollers, track pins, and links.

U.S. Pat. No. 3,779,661 describes a machine and a method for the simultaneous and continuous preparing of a graded surface and the slip forming of a curb and gutter or a sidewalk on the prepared surface. An adjustable frame that is carried over the prepared surface is movably adjusted to positions, in conformance with the grade characteristics of a grade line that is extended along one side of the machine, by means actuated by a grade sensor unit operatively associated with the grade line. The surface traveled by the machine is prepared by a grade trimmer carried at the front end of the adjustable frame and a slip form or mule is extended longitudinally of and supported from the adjustable frame at a position rearwardly of the grade trimmer.

### SUMMARY OF THE DISCLOSURE

In an aspect of the present disclosure, a hinge assembly for an undercarriage system of a work machine is provided. The hinge assembly includes a first bracket assembly disposed proximal to a fore end of the work machine relative to a direction of travel of the work machine. The first bracket assembly includes a first bracket coupled with a track frame of the undercarriage system that is coupled with a track of the undercarriage system. The first bracket assembly also includes a second bracket coupled with a leg column of the undercarriage system. The first bracket and the second bracket are pivotable relative to each other. The hinge assembly also includes a second bracket assembly disposed proximal to an aft end of the work machine relative to the direction of travel of the work machine. The second bracket assembly includes a third bracket coupled with the track frame. The second bracket assembly also includes a fourth bracket coupled with the leg column. The third bracket and the fourth bracket are pivotable relative to each other. The hinge assembly further includes a coupling member that removably couples the first bracket assembly with the second bracket assembly. The first bracket, the second bracket, the third bracket, and the fourth bracket are in alignment with each other to receive the coupling member. The coupling member allows a pivoting of each of the first bracket relative to the second bracket and the third bracket relative to the fourth bracket to allow a pivoting motion of the track about a lateral axis of the work machine. The lateral axis is orthogonal to the direction of travel of the work machine.

In another aspect of the present disclosure, an undercarriage system for a work machine is provided. The undercarriage system includes a track frame. The undercarriage system also includes a track coupled to the track frame. The undercarriage system further includes a leg column. The undercarriage system includes a hinge assembly. The hinge assembly includes a first bracket assembly disposed proximal to a fore end of the work machine relative to a direction of travel of the work machine. The first bracket assembly includes a first bracket coupled with the track frame of the undercarriage system that is coupled with the track of the undercarriage system. The first bracket assembly also includes a second bracket coupled with the leg column of the undercarriage system. The first bracket and the second bracket are pivotable relative to each other. The hinge assembly includes a second bracket assembly disposed proximal to an aft end of the work machine relative to the direction of travel of the work machine. The second bracket assembly includes a third bracket coupled with the track frame. The second bracket assembly also includes a fourth bracket coupled with the leg column. The third bracket and the fourth bracket are pivotable relative to each other. The hinge assembly further includes a coupling member that removably couples the first bracket assembly with the second bracket assembly. The first bracket, the second bracket, the third bracket, and the fourth bracket are in alignment with each other to receive the coupling member. The coupling member allows a pivoting of each of the first bracket relative to the second bracket and the third bracket relative to the fourth bracket to allow a pivoting motion of the track about a lateral axis of the work machine. The lateral axis is orthogonal to the direction of travel of the work machine.

In yet another aspect of the present disclosure, a method of pivoting a track of an undercarriage system of a work machine is provided. The undercarriage system includes a track frame that is coupled with the track of the undercarriage system. The method includes providing a first bracket assembly proximal to a fore end of the work machine relative to a direction of travel of the work machine. The first bracket assembly includes a first bracket coupled with the track frame of the undercarriage system that is coupled with the track of the undercarriage system and a second bracket coupled with a leg column of the undercarriage system. The first bracket and the second bracket are pivotable relative to each other. The method also includes providing a second bracket assembly proximal to an aft end of the work machine relative to the direction of travel of the work machine. The second bracket assembly includes a third bracket coupled with the track frame and a fourth bracket coupled with the leg column. The third bracket and the fourth bracket are pivotable relative to each other. A coupling member of the undercarriage system removably couples the first bracket assembly with the second bracket assembly. The method further includes moving the work machine on a ground surface. The method includes encountering, by the track, an object or a depression that is present on the ground surface. The method also includes causing, via the coupling member, a pivoting of each of the first bracket relative to the second bracket and the third bracket relative to the fourth bracket. The method further includes pivoting the track about a lateral axis of the work machine based on the pivoting of each of the first bracket relative to the second bracket and the third bracket relative to the fourth bracket. The lateral axis is orthogonal to the direction of travel of the work machine.

Other features and aspects of this disclosure will be apparent from the following description and the accompanying drawings.

### BRIEF DESCRIPTION OF THE DRAWINGS

FIG. 1 is a schematic side view of an exemplary work machine;

FIG. 2 is a schematic front view of a portion of an undercarriage system of the work machine of FIG. 1, according to an example of the present disclosure;

FIG. 3 is a schematic side view of a portion of the undercarriage system of FIG. 2; and

FIG. 4 is a flowchart for a method of pivoting a track of the undercarriage system of the work machine of FIG. 1, according to an example of the present disclosure.

### DETAILED DESCRIPTION

Wherever possible, the same reference numbers will be used throughout the drawings to refer to the same or like parts.

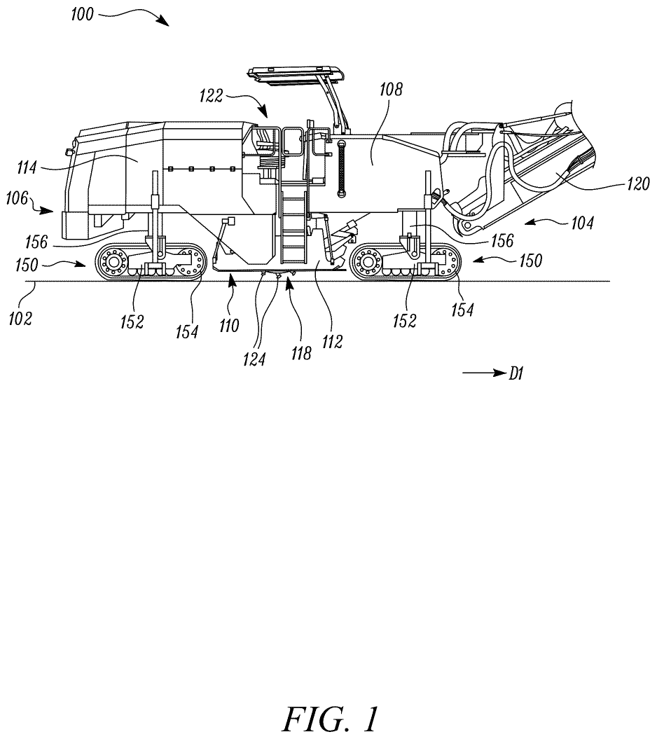

Referring to FIG. 1, a schematic side view of an exemplary work machine 100 is illustrated. The work machine 100 may be a cold planer or a rotary mixer. In the illustrated example of FIG. 1, the work machine 100 is a cold planar. In other examples, the work machine 100 may include an asphalt milling machine, a pavement profiler, a road milling machine, a roadway planer, a rotary mixer, an excavator, a dozer, or any other suitable machine that includes an undercarriage system/tracks.

The work machine 100 defines a fore end 104 and an aft end 106 opposite to the fore end 104. The work machine 100 includes a frame 108. The frame 108 supports various machine components thereon. The work machine 100 further includes a milling enclosure 110 supported by the frame 108. The milling enclosure 110 includes one or more side plates 112. The milling enclosure 110 includes two side plates 112 (only one of the side plate 112 is shown for illustrative purposes) that are spaced apart from each other and disposed on either sides of the work machine 100. The milling enclosure 110 is an enclosed space defined by the side plates 112, a pair of side walls (not shown), a front wall (not shown), and a rear wall (not shown).

The work machine 100 further includes a power source (not shown) that generates power. The power source may be an engine, such as, an internal combustion engine (e.g., a compression ignition diesel engine), a gas turbine engine, a battery system, a fuel cell, and the like. The power source is mounted on the frame 108. The power source is enclosed within an enclosure 114.

The work machine 100 also includes a rotor 118 for milling a work surface. In one example, the rotor 118 may be embodied as a height adjustable rotor. The rotor 118 includes a rotatable drum (or a cylinder) and one or more cutting tools 124 extending from the rotatable drum. The rotor 118 extends between the side plates 112. According to a need of the application, the rotor 118 may be lowered so that the rotor 118 may contact and cut the work surface through forces applied by the one or more cutting tools 124 on the work surface.

The work machine 100 further includes a discharge conveyor 120 disposed at the fore end 104. Material removed from the work surface may enter the discharge conveyor 120 which, for example, may then transfer the removed material into a dump truck (not shown) or other suitable machine for transportation off site.

The work machine 100 further includes an operator station 122 supported by the frame 108. An operator of the work machine 100 may sit or stand in the operator station 122 to overlook machine operations. The operator station 122 may also include different control devices that may be used for controlling one or more machine operations of the work machine 100. The different control devices may include, but are not limited to, pedals, levers, switches, buttons, wheels, and other such devices as are known in the art.

The work machine 100 includes an undercarriage system 150. The undercarriage system 150 allows movement of the work machine 100 on a ground surface 102.

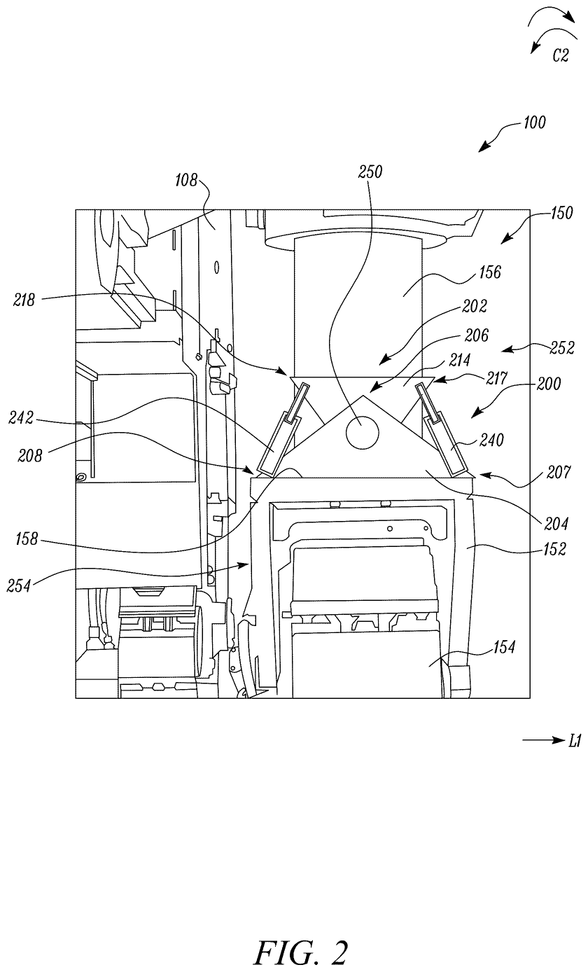

The undercarriage system 150 includes a track frame 152. The track frame 152 defines a top surface 158 (shown in FIG. 2). The undercarriage system 150 also includes a track 154 coupled to the track frame 152. The undercarriage system 150 further includes a leg column 156. The leg column 156 is coupled to the track frame 152. In the illustrated example of FIG. 1, the undercarriage system 150 includes four tracks 154 (only two tracks 154 are visible in FIG. 1, the others are hidden from view), four track frames 152 (only two track frames 152 are visible in FIG. 1, the others are hidden from view), and four leg columns 156 (only two leg columns 156 are visible in FIG. 1, the others are hidden from view). The track frame 152 defines a first side 252 (shown in FIG. 2) and a second side 254 (shown in FIG. 2). Typically, the track frame 152 is movable relative to the leg column 156 in fore and aft directions.

Referring to FIG. 2, a schematic front view of a portion of the undercarriage system 150 of the work machine 100 of FIG. 1 is illustrated. The undercarriage system 150 further includes a hinge assembly 200. The hinge assembly 200 for the undercarriage system 150 of the work machine 100 includes a first bracket assembly 202 disposed at the fore end 104 (see FIG. 1) of the work machine 100 relative to a direction of travel D1 (shown in FIG. 1) of the work machine 100.

The first bracket assembly 202 includes a first bracket 204 coupled with the track frame 152 of the undercarriage system 150 that is coupled with the track 154 of the undercarriage system 150. In the illustrated example of FIG. 2, the first bracket 204 of the first bracket assembly 202 is triangular in shape. In some examples, the first bracket 204 may be square, rectangular, and the like, without limiting the scope of the present disclosure. Further, the first bracket 204 defines a first vertex 206, a second vertex 207, and a third vertex 208. In the illustrated example of FIG. 2, the first bracket 204 rests on and is coupled to the top surface 158 of the track frame 152 at a planar surface of the first bracket 204. In some examples, the first bracket 204 may be coupled with the track frame 152 using any known fastening means, such as, bolts, screws, rivets, and the like. Alternatively, the first bracket 204 may be coupled with the track frame 152 by welding, soldering, brazing, and the like.

The first bracket assembly 202 also includes a second bracket 214 coupled with the leg column 156 of the undercarriage system 150. In the illustrated example of FIG. 2, the second bracket 214 of the first bracket assembly 202 is triangular in shape. In some examples, the second bracket 214 may be square, rectangular, and the like, without limiting the scope of the present disclosure. In some examples, the second bracket 214 may be coupled with the leg column 156 using any known fastening means, such as, bolts, screws, rivets, and the like. Alternatively, the second bracket 214 may be coupled with the leg column 156 by welding, soldering, brazing, and the like. Further, the second bracket 214 defines a first vertex (not shown), a second vertex 217, and a third vertex 218.

Furthermore, the first bracket 204 and the second bracket 214 are pivotable relative to each other. Specifically, the first bracket 204 and the second bracket 214 are pivotable in each of a clockwise direction C1 and an anticlockwise direction C2.

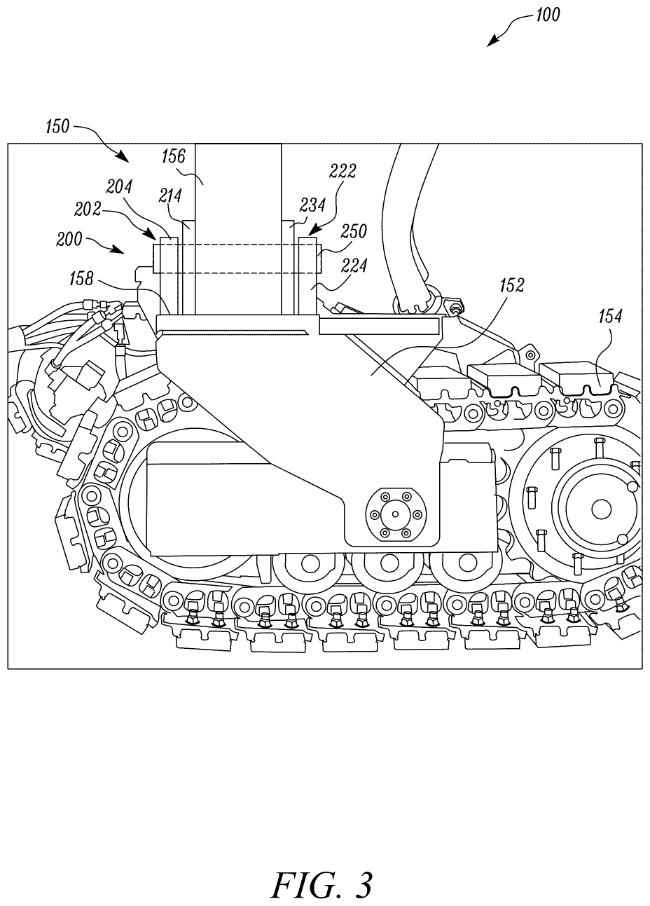

Referring to FIG. 3, a schematic side view of a portion of the undercarriage system 150 of the work machine 100 of FIG. 1 is illustrated. The hinge assembly 200 also includes a second bracket assembly 222 disposed at the aft end 106 (see FIG. 1) of the work machine 100 relative to the direction of travel D1 (see FIG. 1) of the work machine 100.

The second bracket assembly 222 includes a third bracket 224 coupled with the track frame 152. The third bracket 224 is similar in design and dimensions to the first bracket 204.

Similar to the first bracket 204 of the first bracket assembly 202, the third bracket 224 of the second bracket assembly 222 is triangular in shape. In some examples, the third bracket 224 may be square, rectangular, and the like, without limiting the scope of the present disclosure. Further, the third bracket 224 rests on and is coupled to the top surface 158 of the track frame 152 at a planar surface of the third bracket 224. In some examples, the third bracket 224 may be coupled with the track frame 152 using any known fastening means, such as, bolts, screws, rivets, and the like. Alternatively, the third bracket 224 may be coupled with the track frame 152 by welding, soldering, brazing, and the like. Further, similar to the first bracket 204, the third bracket 224 defines a first vertex (not shown), a second vertex (not shown), and a third vertex (not shown).

The second bracket assembly 222 also includes a fourth bracket 234 coupled with the leg column 156. The fourth bracket 234 is similar in design and dimensions to the second bracket 214. Similar to the second bracket 214 of the first bracket assembly 202, the fourth bracket 234 of the second bracket assembly 222 is triangular in shape. In some examples, the fourth bracket 234 may be square, rectangular, and the like, without limiting the scope of the present disclosure. In some examples, the fourth bracket 234 may be coupled with the leg column 156 using any known fastening means, such as, bolts, screws, rivets, and the like. Alternatively, the fourth bracket 234 may be coupled with the leg column 156 by welding, soldering, brazing, and the like. Further, similar to the second bracket 214, the fourth bracket 234 defines a first vertex (not shown), a second vertex (not shown), and a third vertex (not shown).

Furthermore, the third bracket 224 and the fourth bracket 234 are pivotable relative to each other. Specifically, the third bracket 224 and the fourth bracket 234 are pivotable in each of the clockwise direction C1 (see FIG. 2) and the anticlockwise direction C2 (see FIG. 2).

Referring to FIGS. 2 and 3, the hinge assembly 200 further includes one or more first dampers 240 coupled between the track frame 152 and the second bracket 214 of the first bracket assembly 202 and/or the fourth bracket 234 of the second bracket assembly 222. The one or more first dampers 240 are disposed at the first side 252 of the track frame 152.

In one example, the one or more first dampers 240 is a single first damper 240. In other example, the one or more first dampers 240 may include two first dampers 240. In the illustrated example of FIGS. 2 and 3, the one or more first dampers 240 is the single first damper 240 that is coupled with the track frame 152 at one end and to the second vertex 217 of the second bracket 214 of the first bracket assembly 202 at another end. Additionally, or alternatively, the first damper 240 may be coupled with the track frame 152 at one end and to the fourth bracket 234 of the second bracket assembly 222 at another end.

The hinge assembly 200 further includes one or more second dampers 242 disposed opposite to the one or more first dampers 240. The one or more second dampers 242 are coupled between the track frame 152 and the second bracket 214 of the first bracket assembly 202 and/or the fourth bracket 234 of the second bracket assembly 222. The one or more second dampers 242 are disposed at the second side 254 of the track frame 152.

In one example, the one or more second dampers 242 is a single second damper 242. In other example, the one or more second dampers 242 may include two second dampers 242. In the illustrated example of FIGS. 2 and 3, the one or more second dampers 242 is the single second damper 242 that is coupled with the track frame 152 at one end and to the third vertex 218 of the second bracket 214 of the first bracket assembly 202 at another end. Additionally, or alternatively, the second damper 242 may be coupled with the track frame 152 at one end and to the fourth bracket 234 of the second bracket assembly 222 at another end. In some examples, the hinge assembly 200 includes at least one damper 242, 244 at each of the first side 252 and the second side 254 of the track frame 152. Alternatively, the hinge assembly 200 may include a single damper at the first side 252 or the second side 254.

Further, each of the one or more first dampers 240 and the one or more second dampers 242 includes a cylinder or a shock absorber. In some examples, the one or more first dampers 240 and the one or more second dampers 242 may include a spring, an air suspension, and the like, without limiting the scope of the present disclosure.

Furthermore, each of the one or more first dampers 240 and the one or more second dampers 242 dampen a movement of the track 154, limit a range of movement of the track 154, and/or limit a speed of movement of the track 154.

The hinge assembly 200 further includes a coupling member 250 that removably couples the first bracket assembly 202 with the second bracket assembly 222. In the illustrated example of FIGS. 2 and 3, the first bracket 204, the second bracket 214, the third bracket 224, and the fourth bracket 234 are in alignment with each other to receive the coupling member 250. The coupling member 250 may include a bolt, a screw, a pin, and the like.

The coupling member 250 allows a pivoting of each of the first bracket 204 relative to the second bracket 214 and the third bracket 224 relative to the fourth bracket 234 to allow a pivoting motion of the track 154 about a lateral axis L1 of the work machine 100. The lateral axis L1 is orthogonal to the direction of travel D1 (see FIG. 1) of the work machine 100. Specifically, the coupling member 250 allows the pivoting of each of the first bracket 204 relative to the second bracket 214 and the third bracket 224 relative to the fourth bracket 234 in both the clockwise direction C1 and the anticlockwise direction C2 to allow the pivoting motion of the track 154 about the lateral axis L1 of the work machine 100.

Further, the hinge assembly 200 prevents an edge loading on the undercarriage system 150, an uneven stress distribution on the track 154, and/or an uneven wear on the track 154 based on the pivoting of the track 154 about the lateral axis L1 of the work machine 100. Furthermore, the hinge assembly 200 improves a traction provided by the track 154 based on the pivoting of the track 154 about the lateral axis L1 of the work machine 100.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the hinge assembly 200 of the undercarriage system 150 of the work machine 100. The hinge assembly 200 includes the first bracket assembly 202 including the first bracket 204 coupled with the track frame 152 and the second bracket 214 coupled with the leg column 156. The hinge assembly 200 also includes the second bracket assembly 222 including the third bracket 224 coupled with the track frame 152 and the fourth bracket 234 coupled with the leg column 156. The hinge assembly 200 further includes the coupling member 250 which allows the pivoting of each of the first bracket 204 relative to the second bracket 214 and the third bracket 224 relative to the fourth bracket 234 to allow the pivoting motion of the track 154 about the lateral axis L1 of the work machine 100.

Further, the hinge assembly 200 includes the one or more first dampers 240 and the one or more second dampers 242 disposed opposite to the one or more first dampers 240. The first dampers 240 and the second dampers 242 dampen the movement of the track 154, limit the range of movement of the track 154, and/or limit the speed of movement of the track 154, thereby providing improved control of a motion of the track frame 152, and the track 154, when the work machine 100 experiences uneven surfaces, objects, such, as material piles or bumps, and/or depressions, such as holes or trenches, present on the ground surface 102 or the work surface.

The hinge assembly 200 allows the track frame 152, and thereby the track 154, to move in a side-to-side direction relative to the leg column 156 which may improve a range of motion of the track 154. Moreover, the hinge assembly 200 improves a flexibility of the track 154 and an ability of the work machine 100 to move on complex surfaces. The hinge assembly 200 prevents the edge loading on the undercarriage system 150, the uneven stress distribution on the track 154, and/or the uneven wear on the track 154 based on the pivoting of the track 154 about the lateral axis L1 of the work machine 100, which may in turn improve a service life of the tracks 154 and may also reduce a need and costs associated with maintenance/servicing of the tracks 154 and/or other component of the undercarriage system 150.

Furthermore, the hinge assembly 200 improves the traction provided by the track 154 based on the pivoting of the track 154 about the lateral axis L1 of the work machine 100.

Overall, the hinge assembly 200 may be simple in construction, may be cost-effective, and may be durable. Further, the hinge assembly 200 may be retrofitted on existing work machines. Moreover, the hinge assembly 200 may be used on a variety of work machines that include undercarriage systems.

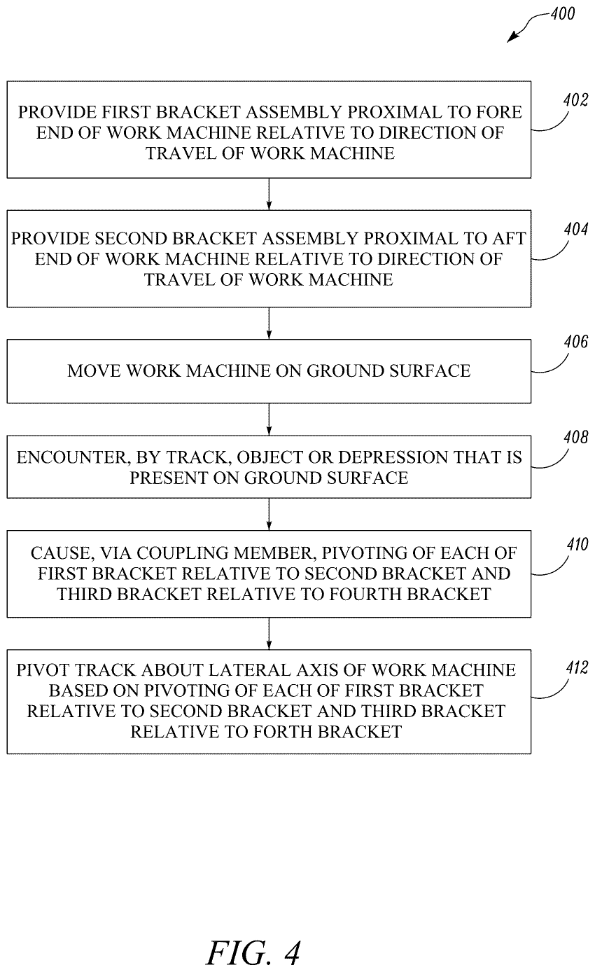

FIG. 4 is a flowchart for a method 400 of pivoting the track 154 of the undercarriage system 150 of the work machine 100. The undercarriage system 150 includes the track frame 152 that is coupled with the track 154 of the undercarriage system 150. Referring to FIGS. 1 to 4, at step 402, the first bracket assembly 202 is provided at the fore end 104 of the work machine 100 relative to the direction of travel D1 of the work machine 100. The first bracket assembly 202 includes the first bracket 204 coupled with the track frame 152 of the undercarriage system 150 that is coupled with the track 154 of the undercarriage system 150 and the second bracket 214 coupled with the leg column 156 of the undercarriage system 150. The first bracket 204 and the second bracket 214 are pivotable relative to each other.

At step 404, the second bracket assembly 222 is provided at the aft end 106 of the work machine 100 relative to the direction of travel D1 of the work machine 100. The second bracket assembly 222 includes the third bracket 224 coupled with the track frame 152 and the fourth bracket 234 coupled with the leg column 156. The third bracket 224 and the fourth bracket 234 are pivotable relative to each other. The coupling member 250 of the undercarriage system 150 removably couples the first bracket assembly 202 with the second bracket assembly 222.

At step 406, the work machine 100 moves on the ground surface 102. The work machine 100 is the cold planer.

At step 408, an object and/or a depression that is present on the ground surface 102 is encountered by the track 154.

At step 410, the coupling member 250 causes each of the first bracket 204 to pivot relative to the second bracket 214 and the third bracket 224 to pivot relative to the fourth bracket 234.

At step 412, the track 154 pivots about the lateral axis L1 of the work machine 100 based on the pivoting of each of the first bracket 204 relative to the second bracket 214 and the third bracket 224 relative to the fourth bracket 234. The lateral axis L1 is orthogonal to the direction of travel D1 of the work machine 100.

The method 400 further includes a step (not shown) at which the undercarriage system 150 further includes the one or more first dampers 240 coupled between the track frame 152 and the second bracket 214 of the first bracket assembly 202 and/or the fourth bracket 234 of the second bracket assembly 222 and the one or more second dampers 242 disposed opposite to the one or more first dampers 240. The one or more second dampers 242 are coupled between the track frame 152 and the second bracket 214 of the first bracket assembly 202 and/or the fourth bracket 234 of the second bracket assembly 222. Each of the one or more first dampers 240 and the one or more second dampers 242 includes the cylinder or the shock absorber.

The method 400 further includes a step (not shown) at which the one or more first dampers 240 and the one or more second dampers 242 dampen the movement of the track 154, limit the range of movement of the track 154, and/or limit the speed of movement of the track 154.

The method 400 further includes a step (not shown) at which the edge loading on the undercarriage system 150, the uneven stress distribution on the track 154, and/or the uneven wear on the track 154 is prevented based on the pivoting of the track 154 about the lateral axis L1 of the work machine 100.

The method 400 further includes a step (not shown) at which the traction provided by the track 154 is improved based on the pivoting of the track 154 about the lateral axis L1 of the work machine 100.

It should be noted that the steps 402, 404, 406, 408, 410, 412 of the method 400 may be performed in a sequence that is different from that explained in relation to FIG. 4. Further, various steps 402, 404, 406, 408, 410, 412 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A hinge assembly for an undercarriage system of a work machine, the hinge assembly comprising:
a first bracket assembly disposed proximal to a fore end of the work machine relative to a direction of travel of the work machine, the first bracket assembly including:
a first bracket coupled with a track frame of the undercarriage system that is coupled with a track of the undercarriage system; and
a second bracket coupled with a leg column of the undercarriage system, wherein the first bracket and the second bracket are pivotable relative to each other;
a second bracket assembly disposed proximal to an aft end of the work machine relative to the direction of travel of the work machine, the second bracket assembly including:
a third bracket coupled with the track frame; and
a fourth bracket coupled with the leg column, wherein the third bracket and the fourth bracket are pivotable relative to each other; and
a coupling member that removably couples the first bracket assembly with the second bracket assembly, wherein the first bracket, the second bracket, the third bracket, and the fourth bracket are in alignment with each other to receive the coupling member, wherein the coupling member allows a pivoting of each of the first bracket relative to the second bracket and the third bracket relative to the fourth bracket to allow a pivoting motion of the track about a lateral axis of the work machine, and wherein the lateral axis is orthogonal to the direction of travel of the work machine.

2. The hinge assembly of claim 1 further comprising:
at least one first damper coupled between the track frame and any one of the second bracket of the first bracket assembly and the fourth bracket of the second bracket assembly; and
at least one second damper disposed opposite to the at least one first damper, wherein the at least one second damper is coupled between the track frame and any one of the second bracket of the first bracket assembly and the fourth bracket of the second bracket assembly.

3. The hinge assembly of claim 2, wherein each of the at least one first damper and the at least one second damper includes a cylinder or a shock absorber.

4. The hinge assembly of claim 2, wherein each of the at least one first damper and the at least one second damper is adapted to at least one of dampen a movement of the track, limit a range of movement of the track, and/or limit a speed of movement of the track.

5. The hinge assembly of claim 1, wherein each of the first bracket and the second bracket of the first bracket assembly is triangular in shape.

6. The hinge assembly of claim 1, wherein each of the third bracket and the fourth bracket of the second bracket assembly is triangular in shape.

7. The hinge assembly of claim 1, wherein the work machine is a cold planer.

8. An undercarriage system for a work machine, the undercarriage system comprising:
a track frame;
a track coupled to the track frame;
a leg column; and
a hinge assembly including:
a first bracket assembly disposed proximal to a fore end of the work machine relative to a direction of travel of the work machine, the first bracket assembly including:
a first bracket coupled with the track frame of the undercarriage system that is coupled with the track of the undercarriage system; and
a second bracket coupled with the leg column of the undercarriage system, wherein the first bracket and the second bracket are pivotable relative to each other;
a second bracket assembly disposed proximal to an aft end of the work machine relative to the direction of travel of the work machine, the second bracket assembly including:
a third bracket coupled with the track frame; and
a fourth bracket coupled with the leg column,
wherein the third bracket and the fourth bracket are pivotable relative to each other; and
a coupling member that removably couples the first bracket assembly with the second bracket assembly, wherein the first bracket, the second bracket, the third bracket, and the fourth bracket are in alignment with each other to receive the coupling member, wherein the coupling member allows a pivoting of each of the first bracket relative to the second bracket and the third bracket relative to the fourth bracket to allow a pivoting motion of the track about a lateral axis of the work machine, and wherein the lateral axis is orthogonal to the direction of travel of the work machine.

9. The undercarriage system of claim 8, wherein the hinge assembly further includes:
at least one first damper coupled between the track frame and any one of the second bracket of the first bracket assembly and the fourth bracket of the second bracket assembly; and
at least one second damper disposed opposite to the at least one first damper, wherein the at least one second damper is coupled between the track frame and any one of the second bracket of the first bracket assembly and the fourth bracket of the second bracket assembly.

10. The undercarriage system of claim 9, wherein each of the at least one first damper and the at least one second damper includes a cylinder or a shock absorber.

11. The undercarriage system of claim 9, wherein each of the at least one first damper and the at least one second damper is adapted to at least one of dampen a movement of the track, limit a range of movement of the track, and/or limit a speed of movement of the track.

12. The undercarriage system of claim 8, wherein each of the first bracket and the second bracket of the first bracket assembly is triangular in shape.

13. The undercarriage system of claim 8, wherein each of the third bracket and the fourth bracket of the second bracket assembly is triangular in shape.

14. The undercarriage system of claim 8, wherein the work machine is a cold planer.

15. A method of pivoting a track of an undercarriage system of a work machine, the undercarriage system including a track frame that is coupled with the track of the undercarriage system, the method comprising:
providing a first bracket assembly proximal to a fore end of the work machine relative to a direction of travel of the work machine, wherein the first bracket assembly includes a first bracket coupled with the track frame of the undercarriage system that is coupled with the track of the undercarriage system and a second bracket coupled with a leg column of the undercarriage system, and wherein the first bracket and the second bracket are pivotable relative to each other;
providing a second bracket assembly proximal to an aft end of the work machine relative to the direction of travel of the work machine, wherein the second bracket assembly includes a third bracket coupled with the track frame and a fourth bracket coupled with the leg column, wherein the third bracket and the fourth bracket are pivotable relative to each other, and wherein a coupling member of the undercarriage system removably couples the first bracket assembly with the second bracket assembly;
moving the work machine on a ground surface;
encountering, by the track, an object or a depression that is present on the ground surface;
causing, via the coupling member, a pivoting of each of the first bracket relative to the second bracket and the third bracket relative to the fourth bracket; and
pivoting the track about a lateral axis of the work machine based on the pivoting of each of the first bracket relative to the second bracket and the third bracket relative to the fourth bracket, wherein the lateral axis is orthogonal to the direction of travel of the work machine.

16. The method of claim 15, wherein the undercarriage system further includes at least one first damper coupled between the track frame and any one of the second bracket of the first bracket assembly and the fourth bracket of the second bracket assembly and at least one second damper disposed opposite to the at least one first damper, and wherein the at least one second damper is coupled between the track frame and any one of the second bracket of the first bracket assembly and the fourth bracket of the second bracket assembly, the method further comprising:
at least one of dampening a movement of the track, limiting a range of movement of the track, and/or limiting a speed of movement of the track via the at least one first damper and the at least one second damper.

17. The method of claim 16, wherein each of the at least one first damper and the at least one second damper includes a cylinder or a shock absorber.

18. The method of claim 15, wherein the work machine is a cold planer.

19. The method of claim 15 further comprising:
preventing at least one of an edge loading on the undercarriage system, an uneven stress distribution on the track, and an uneven wear on the track based on the pivoting of the track about the lateral axis of the work machine.

20. The method of claim 15 further comprising:
improving a traction provided by the track based on the pivoting of the track about the lateral axis of the work machine.
